(19) United States
(12) Patent Application Publication
(10) Pub. No.: US 2008/0261569 A1
(43) Pub. Date: Oct. 23, 2008

(54) Integrated messaging, contacts, and mail interface, systems and methods

(75) Inventors: Douglass J. Britt, Santa Monica, CA (US); Matias Duarte, Los Angeles, CA (US); Peter J. Ford, Los Angeles, CA (US); Han Yeol (Hunt) Ahn, Los Angeles, CA (US)

Correspondence Address: K&L Gates LLP, STATE STREET FINANCIAL CENTER, One Lincoln Street, BOSTON, MA, 02111-2950, US

(73) Assignee: Helio, LLC, Los Angeles, CA (US)

(21) Appl. No.: 11/975,838

(22) Filed: Oct. 22, 2007

Related U.S. Application Data
(60) Provisional application No. 60/925,963, filed on Apr. 23, 2007.

(51) Int. Cl. H04M 3/42; H04M 1/00; G06F 3/048

(52) U.S. Cl. 455/414.1; 455/566; 715/841

(57) ABSTRACT

Systems and methods for integrating and aggregating content for a mobile device are provided. Electronic content gathered from service providers over a network is presented in an intuitive, efficient and effective manner to easily allow a mobile device user seamless access to a variety of electronic content and functionality. An integrated message system for organizing information for registered accounts on a mobile device is also provided. The system includes an aggregated content interface presenting a number of service provider indicators. The system also includes submenus corresponding to each of the service provider indicators of the aggregated content interface. Each of the submenus includes a plurality of tabbed interfaces that replicate the functionality of a service provider.

### CROSS REFERENCE TO RELATED APPLICATIONS

This application claims the benefit of U.S. Provisional patent application No. 60/925,963 filed Apr. 23, 2007, the entire disclosure of which is incorporated herein by reference.

### FIELD OF THE INVENTION

The present invention relates generally to user interfaces for mobile electronic communications and, more particularly, to a system and method for aggregating and displaying content on a mobile device.

### BACKGROUND OF THE INVENTION

As the proliferation of mobile electronic communications has increased, the need to efficiently and easily access content over a network has also greatly increased. Advances in technology allow a user to access a wide variety of content and information over a network such as WiFi, or cellular networks. Mobile devices now include browsing functionality allowing a user to access content, such as a web page, photos, music and video on the Internet.

Typical mobile devices utilize a “mini-browser” application that creates a portal from the mobile device to the Internet content. Such browsers are often limited in functionality due to security requirements, and software capabilities inherent to many mobile devices. Mobile devices, while having made great technological strides, are not yet capable of processing and displaying the data in the equivalent manner of a desktop or laptop computer. Due to these inherent limitations of mobile devices, viewing content from the Internet can be cumbersome and illegible if the content being viewed is not specifically formatted for a mobile device platform.

The access to wide-spread use of free Internet email, chat and contact storage can be one such limitation inherent with the mobile internet. Many online service providers, such as Yahoo!™, AOL™, Microsoft™, and Google™, offer an online suite of applications allowing a user access to email, instant messaging chat, or address book contacts from any computer having Internet access. A user simply logs into the service and is presented with his or her personal inbox, chat forum or contact list. The data from the user's account is stored on a server, not the user's computer, allowing the user access from any location. Many users take advantage of the nature of these online accounts and possess multiple accounts across the various service providers.

The increased sophistication of mobile devices and these online service providers's focus on mobile now includes the ability to access the functionality provided by these service providers through customized software applications. A user having accounts with multiple service providers is now able to access certain data across the different service providers' platforms from within one solution. However, today a user logged into one account does not have access to the address book, alerts or emails existing in another account. The user must leave that account and log in to the other. However, repeating such a process becomes tedious and time-consuming when accessing such services through a mobile device.

What is needed therefore are methods, systems, subsystems, and other device solutions for an interface for mobile electronic devices that present a user with content from a variety of mobile messaging content types and service providers in an intuitive, easily manageable and efficient manner. A solution is also needed to provide access to various sources of users' contact information. Additionally, what is needed is the provision of necessary visual and audio alerts and notification when new messages, requests for instant messaging chats, or contact profiles change.

### SUMMARY OF THE INVENTION

Embodiments of the present invention provide systems and methods for an integrated content system for a mobile device. Electronic content gathered from service providers over a network is presented in an intuitive, efficient and effective manner to easily allow a mobile device user seamless access to a variety of electronic content and functionality. These functionalities may include, without limitation, e-mail, instant messaging, chat, contacts, address book, logs, presence indicators, notifications or archives. In general, the aspects of the invention disclosed herein are suited and adapted for making all forms of non-verbal communication applications offered from a plurality of vendors and companies available via an efficient and intuitive graphic user interface.

In one aspect, the invention provides a system for organizing information for registered accounts on a mobile device. The system includes an aggregated content interface presenting a number of service provider indicators. In one embodiment, the interface is a page or portal on a mobile device. The system further includes submenus corresponding to each of the service provider indicators of the aggregated content interface. Each of the submenus includes a plurality of tabbed interfaces that replicate the functionality of the service provider.

In another aspect, the invention relates to a method of aggregating content from a plurality of service providers on a mobile device. The method includes the steps of presenting a plurality of service provider indicators in an aggregated content display pane, each of the indicators providing a link to a submenu; presenting a plurality of messaging solutions for a service provider in a common display pane, at least one of the messaging solutions having a tabbed arrangement for instant messaging and email functions; retrieving content over a network from each of the plurality of service providers; and populating the submenu with the content, the submenu including a plurality of tabbed interfaces, each of the plurality of tabbed interfaces replicating a functionality of the service provider and displaying the content retrieved from the service provider.

Features of the invention include the aggregated content interface further having a contact indicator with a link to a contact submenu that contains aggregated contact data from the plurality of service providers. The system also features the contact data having a source indicator indicating the service provider from which the contact data is presented. Other features of the system include, without limitation, an online indicator signifying a contact is online and a status indicia of the registered account that may, among other things, indicate a number of unread messages out of a number of total messages.

Another embodiment of the invention includes a method of aggregating content from a plurality of service providers on a mobile device by presenting a plurality of service provider indicators in an aggregated content display. Each of the indicators provides a link to a submenu. The content is then retrieved over a network from each of the plurality of service providers. The submenus are populated with the content including a plurality of tabbed interfaces. Each of the tabbed interfaces replicates a functionality of the service provider and displays the content retrieved from the service provider. The functionality may include e-mail, instant messaging, chat, contacts, address book, logs, or archives.

Additional features of the invention also include an aggregated contact list, including a portion of the content received from each of the service providers. The method also includes indicating an online status of a contact from the contact list, indicating the source of the contact data.

Another embodiment of the invention includes a mobile device having an input device adapted to send a signal, a processor adapted to receive the signal, a display adapted to display a plurality of informational objects and a plurality of graphic user interface screens displayed in response to actuation of the input device. At least one of the graphic user interface screens may be a message aggregating portal that displays a plurality of third party messaging services and messaging service functions. The messaging service functions associated with third party service providers are accessible via the aggregating portal.

Additional features of the mobile device include the messaging services associated with the device being accessible via the messaging aggregating portal. The mobile device also includes a contact aggregation module adapted to display address and contact information for all of the third party messaging services in the messaging aggregating portal. The mobile device displays inbox mail counts for each of the plurality of third party messaging services using the messaging aggregating portal.

Another embodiment of the invention provides a method of organizing messaging services on a mobile device by aggregating a plurality of messaging services on the mobile device according to a hierarchical scheme and displaying a messaging graphic user interface in response to actuation of an input device. The messaging graphic user interface includes a plurality of identifiers associated with at least one messaging service.

Features of the method also include network polling of a portion of the plurality of service providers to receive notification of new messages. Upon receipt of new email messages or requests to engage in an instant message chat, one aspect of the invention initiates a customized notification from the server to the device. That is a customized background initiation of a data session occurs to retrieve the email or instant message content. Upon successful delivery of the content to the device, one aspect of the invention then provides a visual and audio alert to the user of the new message. The messaging graphic user interface aggregates the series of both system and other device notifications (eg, voicemail, text message, etc. . . . ) into a single information manager for the mobile device. This customized background polling when accessed for a portion of the plurality of service providers will also update contact on-line status indicators when the messaging graphic user interface is accessed and polling a portion of the plurality of service providers to update inbox mail counts when the messaging graphic user interface is accessed.

Yet another embodiment includes a personal information manager subsystem adapted for use on a mobile device. The device includes a network interface for accessing third party messaging service providers, a processor programmed to instruct the network interface to retrieve personal contact information from a plurality of third party messaging services, a display in electrical communication with the processor and a graphical user interface. The graphical user interface is presented to a user via the display and displays a master contact list that aggregates all of the retrieved personal contact information from the plurality of third party messaging services. The third party messaging systems include, but are not limited to gmail, Hotmail, Yahoo mail and Outlook. In one embodiment, the third party messaging services are selected from the group consisting of Yahoo! mail, AOL mail, AIM mail, Microsoft's Hotmail, WindowsLive, Google's gMail, Earthlink's email, an IMAP solution, and a POP3 solution. In another embodiment, the third party messaging services are selected from the group consisting of Yahoo! IM, AOL's AIM, Microsoft's MSN, and WindowsLive.

Embodiments of the invention provide additional features to allow for appropriate messaging controls associated with sending, receiving, reading, and managing email communication. Such features provide consistentency in these controls while adjusting them as necessary based upon various online service provider requirements. This adjustment extends to those requirements which the integrated messaging system allows user to customize.

Embodiments of the invention provide additional features to allow for appropriate messaging controls associated with sending, receiving, reading, and managing instant messaging chat communications. Such features provide consistentency in these controls while modifying them as necessary based upon various online service provider requirements

Although, the invention relates to different aspects and embodiments, it is understood that the different aspects and embodiments disclosed herein can be integrated together as a whole or in part, as appropriate. Thus, each embodiment disclosed herein can be incorporated in each of the aspects to varying degrees as appropriate for a given implementation. Furthermore, although some aspects and embodiments are described using “means for” terminology, it is understood that all aspects, embodiments, and other concepts disclosed herein can serve as support for means plus function claims, even if specific “means for” language is not used in a specific portion of the written description.

It should be understood that the terms “a,” “an,” and “the” mean “one or more,” unless expressly specified otherwise.

The foregoing, and other features and advantages of the invention, as well as the invention itself, will be more fully understood from the description, drawings, and claims which follow.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a functional block diagram that illustrates mobile device components in accordance with an embodiment of the present invention;

FIG. 2 is a diagram of an exemplary network suitable for use with embodiments of the present invention;

FIGS. 3-31 are representative diagrams of a display within an aggregated/integrated contact list in accordance with an embodiment of the present invention; and

FIGS. 32-55 are illustrative diagrams of a display within an aggregated/integrated message system in accordance with an embodiment of the present invention.

### DETAILED DESCRIPTION

The invention will be more completely understood through the following detailed description, which should be read in conjunction with the attached drawings. Detailed embodiments of the invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the invention in virtually any appropriately detailed embodiment.

It should be understood that the order of the steps of the methods of the invention is immaterial so long as the invention remains operable. Moreover, two or more steps may be conducted simultaneously unless otherwise specified.

In the following discussion of illustrative embodiments, a “mobile device” includes, without limitation, mobile phones, personal digital assistants, hand-held computers, ultra-mobile personal computers, and the like. The term “informational object” refers to information, in any form, that can be processed on the mobile device including, but not limited to, email, pictures, text messages, user profiles, instant messages, chat requests and address book entries.

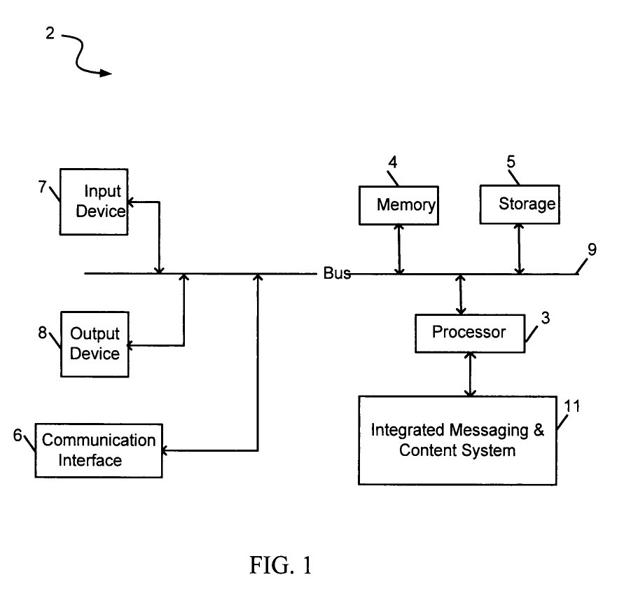

FIG. 1 is a functional block diagram that illustrates the components of an exemplary mobile device for practicing an embodiment of the present invention. The mobile device 2 includes a processing unit or processor 3, a system memory 4, a disk storage 5, a communication interface 6, an input device 7, an output device 8, and a system bus 9. The system bus 9 couples system components including, but not limited to, the system memory 4 to the processing unit 3. The processing unit 3 can be any of various available processors.

The input device 7 may be, without limitation, a keyboard, thumbboard, touchscreen (for use with a stylus), microphone, or any other interface used to receive data from a user. In addition, input device 7 can also include a plurality of other inputs or controls for adjusting and configuring one or more aspects of the present invention including, but not limited to voice commands. The output device 8 may be a display device, such as an LCD or LED display screen, that can display one or more display objects (not shown) such as configurable icons, buttons, input boxes, menus, tabs, or key labels having multiple configurable dimensions, shapes, colors, text, data and sounds to facilitate operations with the mobile device 2.

The communication interface 6 facilitates data exchange over a variety of wireless networks. The hardware and software necessary for connection to the communication interface 6 includes, for example, internal and external components that transmit and receive data wirelessly using a plurality of standard protocols including, for example, PCS, GSM, CDMA, Bluetooth, WiFi, IrDA, WiMAX, WiBRO or through other known wireless standards.

Storage 5 may include removable or fixed, volatile or non-volatile or permanent or re-writable computer storage media. The computer readable medium can be any available medium that can be accessed by a general purpose or special purpose mobile device. By way of example, and not limitation, such a computer readable medium can comprise flash memory, RAM, ROM, electrically erasable programmable read only memory (EEPROM), optical disk storage, magnetic disk storage or other magnetic storage devices, or any other medium that can be used to store digital information on a mobile device.

The processor 3 executes and controls an integrated/aggregated messaging and content system (“IMS”) 11 in accordance with an embodiment of the invention. The integrated content system, as described in greater detail below, includes a system to present electronic content gathered from service providers over a network in an intuitive, efficient and effective manner to easily allow a mobile device user seamless access to a variety of electronic content and functionality. These functionalities may include, without limitation, e-mail, instant messaging, chat, contacts, address book, logs, presence indicators, notifications or archives.

It is to be appreciated that FIG. 1 describes software that acts as an intermediary between users and the basic resources described in mobile device 2. Such software preferably includes an operating system. The operating system, which can be resident in the storage 5, acts to control and allocate resources of mobile device 2. System applications take advantage of the management of resources by the operating system through program modules and program data stored either in the system memory 4 or on storage 5. Furthermore, it is to be appreciated that embodiments of the present invention can be implemented with various operating systems or combinations of operating systems without deviating from the scope of the invention.

The computer readable medium tangibly embodies a program, functions, and/or instructions that cause the computer system to operate in a specific and predefined manner as described herein. Those skilled in the art will appreciate, however, that the process described below, may be implemented at any level, ranging from hardware to application software and in any appropriate physical location. For example, the present invention may be implemented as software code to be executed by mobile device using any suitable computer language and may be stored on any of the storage media described above, or can be configured into the logic of mobile device 2. Such software code may be executed by mobile device using any suitable computer language such as, for example, Java, Javascript, C++, C, C#, Perl, Visual Basic, Transact/Structure Query Language (T/SQL), database languages, APIs, various system-level SDKs, assembly, firmware, microcode, and/or other languages and tools.

The aspects of the invention described herein can be implemented using various architectures and platforms. For example, in one embodiment approaches and solutions based upon the WIPI (Wireless Internet Platform for Interoperability) are used. In another embodiment, solutions and approaches provided by fastmobile (Rolling Meadows, Ill.) can be used in conjunction with aspects of the invention. In a still further embodiment, general client-server systems and polling techniques can be used to support the interface aspects of the invention.

These are representative components of a mobile device whose operation is well understood. Furthermore, those of ordinary skill in the art will appreciate that mobile device 2 of FIG. 1 is exemplary only and that the present invention can operate within a number of different mobile devices.

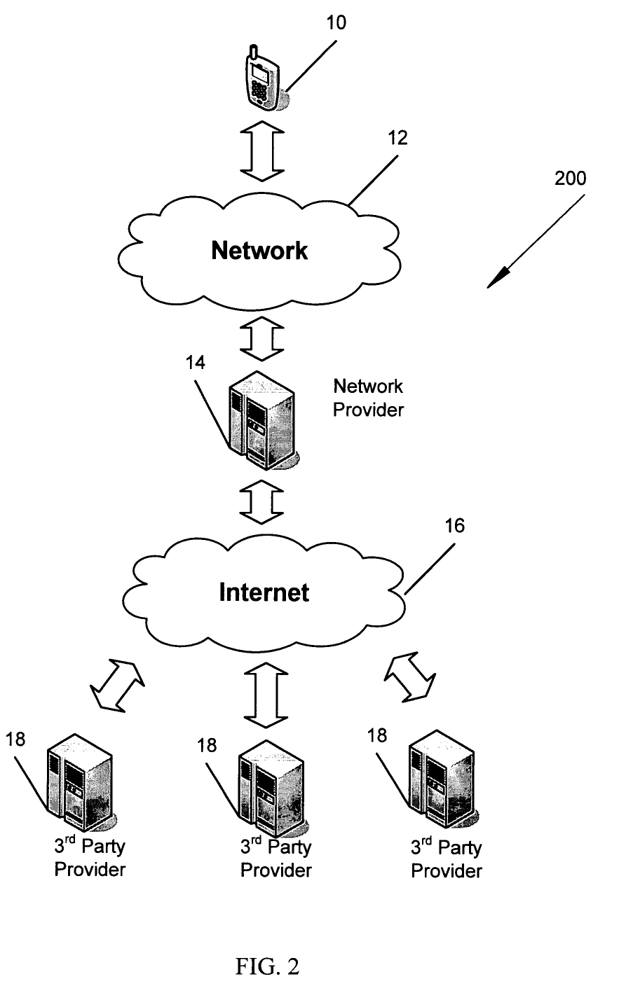

Turning now to FIG. 2, a diagram of a representative network 200 is shown in accordance with an embodiment of the invention. In general, the aspects of the invention disclosed herein can be used with any and all networks that support mobile devices. A mobile device 10 communicates over a network 12 with a wireless communications device server (“WCDS”) 14. The WCDS 14 may be, for example, a cellular telephone provider, wireless Internet provider, or other network provider. Those skilled in the art will readily recognize that various standard protocols for communication between the mobile device 10 and the WCDS 14 may be implemented in the embodiments disclosed herein. For example, wireless Internet platform for interoperability (WIPI), a standard specification for mobile platforms made by the mobile platform special subcommittee of the Korea wireless Internet standardization forum (KWISF), may be used. These are standard specifications necessary for providing an environment for mounting and implementing applications downloaded via wireless Internet on the mobile devices 10.

The WCDS is connected to the Internet 16 over another network, in which a plurality of service providers 18 is also connected. In various embodiments of the invention, the WCDS 14 may be implemented as a computer system and include processing units, memory units and I/O components. In the illustrative example of FIG. 2, three 3^{rd} party service providers 18 are shown. Although the number of 3^{rd} party providers 18 is not limited in number, as shown these three providers could include, for example, Yahoo!™, AOL™ and Google™.

Further, as shown in FIG. 2, each of the three providers 18 shown interacting with the Internet 16 may represent software application interactions with a mobile device user or services being accessed by the user, such as email or instant messaging offered by Yahoo!™, AOL™, Microsoft MSN™ and Google™. Typically, to access such services a user has multiple registered accounts with a plurality of 3^{rd} party providers 18 and/or the software and services they offer. For example, if a user downloads and installs a chat client, they typically register at the time of download, and that registration, in the form of login and password is required to use the chat services on their mobile device or home computer.

In one aspect of the invention, a mobile device 10, either directed by a user, or subject to an automated policy or schedule, communicates over the network 12 requesting content or an informational object, from the network or a 3^{rd} party provider 18. If the request is for 3^{rd} party content, i.e. not hosted by the WCDS 14, the request is sent over the Internet 16 to the specific host of the requested content. The 3^{rd} party provider 18, subject to any authorization or connection requirements, returns the requested information object to the WCDS 14 which in turn, transmits the informational object on to the mobile device 10.

An illustrative example of such an embodiment may include a user communicating through a chat client on a mobile device 10. The user initiates a message or chat, and transmits or “sends” the message over the network 12. The message travels to the WCDS 14 of the network provider, which, if not the host of the chat service, transmits the message via the Internet 16 to the appropriate service provider 18. The service provider 18 receives the message and processes it by notifying the message recipient of an incoming message. The service provider 18 may then transmit a confirmation message or the. recipient's reply back to the user in the same manner: over the Internet 16 to the network provider's WCDS 14, and then to the user's mobile device 10.

This transmission of information using third party providers and different networks such as Wi-Fi, Wi-Max, cellular, and the Internet is used in all types of messaging applications including voice calls, text messages, emails, instant messaging/chat, and other general messaging services of interest to mobile device users. As a result, one aspect of the invention relates to a general messaging platform or portal with an associated interface that combines all of these messaging services into one easy to use interface. This integrated messaging platform can be implemented as a pre-loaded software application for use on a mobile device.

In one embodiment, a messaging interface program and other associated software modules or libraries are resident in the device's memory or storage. The messaging interface allows multiple messaging services to grouped, integrated, and/or aggregated using a common platform. For example, multiple email accounts associated with different third party providers and multiple mobile instant messaging applications and services associated with different third party services can all be grouped within a common messaging interface.

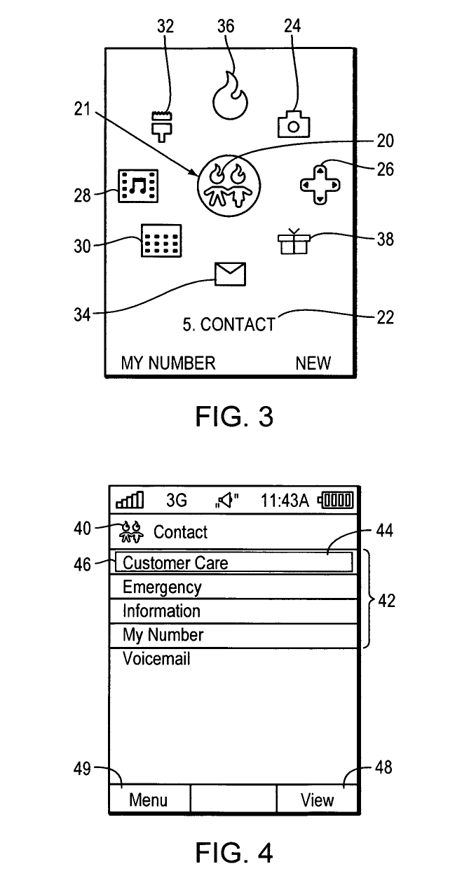

A common messaging interface allows all facets of messaging communication using a mobile device to be organized in an intuitive hierarchy. As shown in the attached figures, and in the high level graphic user interface embodiment depicted in FIG. 3, the systems, methods, and interfaces described herein can aggregate all of the functions and applications available on a mobile device using one intuitive format.

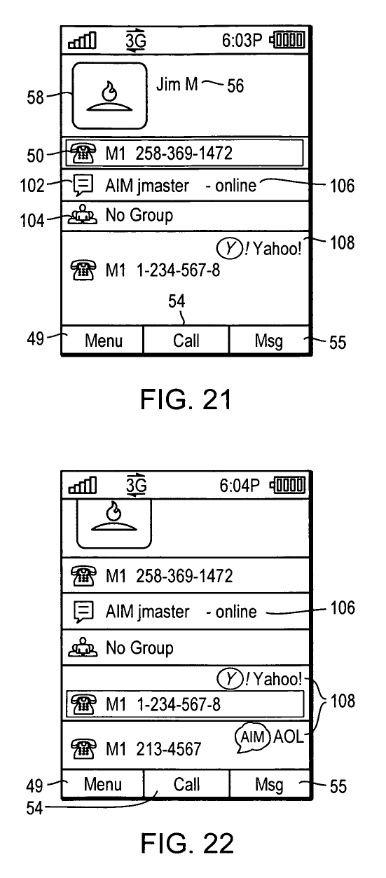

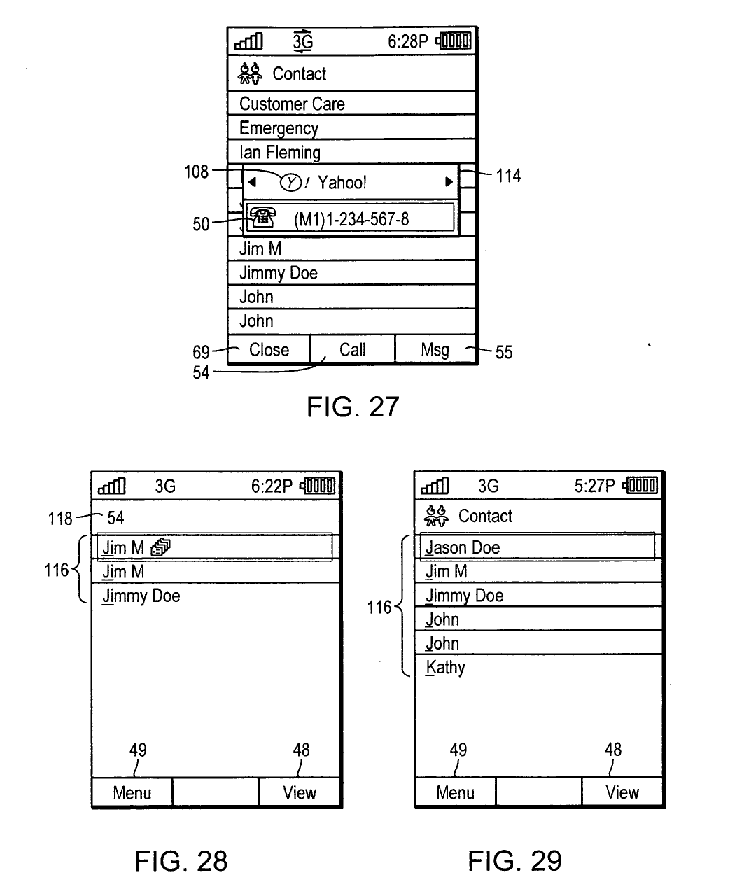

In one embodiment an envelope or other icon (as seen in FIGS. 3-34) can be actuated to access an aggregating user interface for all aspects of messaging communications. In one embodiment, this interface can be implemented on a mobile device that incorporates modeless search features and a general modeless architecture for initiating applications on the device. Additionally, the one embodiment of the invention incorporates device key commands (“shortcuts”) from idle mode operations to quickly access the primary or sub-elements of the aggregated user interface for messaging communications.

The use of one common messaging graphic user interface provides, among other things, the ability to send and receive emails, access to instant messaging clients such as AIM or MSN Messenger, access to text message and SMS message applications, tracking of inbox counts across multiple service providers, and active tracking of instant messaging contacts. The aggregating feature of this embodiment allows essentially all aspects of messaging communication to be displayed simultaneously with real-time data updates of inbox counts and friend tracking using one mobile device interface. An example of a common messaging and/or aggregating portal interface is shown in FIG. 33.

It follows that when aggregating multiple messaging platforms for a mobile device that contact management and address book interactions presents an information management problem for a device user. The applications, systems, and methods recited herein address this problem. Specifically, one aspect of the invention is directed to a universal address book/universal contacts list that may be accessed from a main or idle screen. Some of these features are shown in FIGS. 4, 23, and 24.

Thus, friends, business contacts, phone numbers, buddy lists, and other information associated with a plurality of address books and contacts lists, even though they span multiple services and multiple applications, are all aggregated using one interface. For example, one exemplary universal contact list embodiment displays,a single interface that automatically allows a user to view their Yahoo!™, AOL™ and Google™ contacts/profiles simultaneously, (for example, by using a partitioned interface pane, and/or a plurality of linked scrollable panes) or sequentially by using different tabs or separately linked application specific interface panes. One embodiment of some of these features is shown in FIG. 24.

In one embodiment, intelligent filtering may be applied to remove redundant visual entries in some embodiments. Intelligent filtering recognizes duplicate contact entries from multiple provider sources. Similarly, cross-population between different address books may be possible in some embodiments.

Aspects of the invention described herein allow a user to provide password and login information via their mobile device, as shown in FIG. 37, such that the device can automatically log into different third party service providers and software applications to obtain information and maintain a connection to the data stored at third party servers. This feature allows email, instant messaging contact lists, and address book contact information associated with multiple third party applications to be accessed automatically when a user selects the universal contacts list or as an update when the device is energized. That is, within the overall messaging platform and its aggregating user interface, aspects of the invention pull information from multiple sources of personal information and manage it using an organized user interface window or windows. This allows email inbox counts and friend tracking to be updated continuously or whenever a user accesses the universal contacts icon or the overall messaging interface.

As discussed above, one aspect of the invention includes an aggregated address book or contact list. One embodiment of the invention provides access to contacts via device softkey commands from the device idle mode for one-click access. Additionally, as depicted in the representative display diagrams of FIGS. 3-31. The display of the mobile device, as in FIG. 3, presents the user with a variety of native functionalities resident on the device. An aggregated contacts list 20 can be accessed from a general hierarchical graphic user interface on a mobile device using any suitable icon or other representation, such as the two helion icons touching hands indicating contacts/friends, as seen in the representative display of FIG. 3. To access the aggregated contacts list, the user highlights or scrolls a focus circle 21 to the contact list, here the central icon, and confirms the selection by pressing a confirmation key. The functionality highlighted by the focus circle 21 of this embodiment, is given in a descriptor field 22 below the circle of options. Examples of other functionalities include, without limitation, a camera 24, games 26, applications 38, music and video 28, calendar 30, messaging 34, Internet browser 36, customize and settings 32.

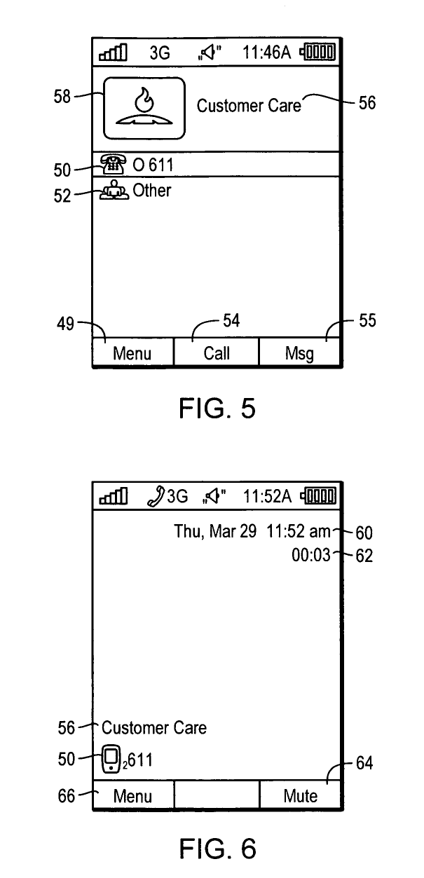

After selection of the contacts list, the user is then presented with a display such as the display of FIG. 4. An informational heading 40 signifying the entry into the “contact” menu and a listing of several pre-set informational objects 42 are displayed. The user may select a particular informational object by scrolling a highlighted focus element 44 to the desired object. In the display of FIG. 4, the contact 46 listed as “Customer Care” is the desired contact. Confirmation of the selection will present a consolidated view of all available contact information fields, by pressing a selection key or soft key 48, and then presenting a display such as that of FIG. 5. The display includes data relating to the contact known as “Customer Care,” such as a phone number 50 and group 52. Possible groups 52 may include, without limitation, friends, family work, co-workers, school, other, none or other user defined groups.

For non-pre-set contacts created by users, all available information fields with details will be displayed. Such fields may include, without limitation, photo icon, email addresses, phone numbers and associated quick dial keys, instant messaging IDs, various 3rd party application IDs such as MySpace, physical addresses, notes, web URL and other defined details. In one embodiment, the contact listing page includes the name of the contact 56 and a user selected individual identifier 58, such as a logo, picture, or avatar specific to the contact. As explained below in greater detail a variety of additional data may be presented that is specific to each contact. The user may also press a “menu” soft key 49 to display additional options for the highlighted contact 46. The user may also initiate sending the contact a message, via short messaging system (“SMS”), email, chat, or other protocol, by selecting the soft key labeled “Msg.”

While embodiments of the invention described herein refer to soft keys as actuating or initializing functions, one skilled in the art should recognize that any resource designed for user input may be implemented without deviating from the scope of the invention. For example, hard coded function keys, touchscreen activation, voice commands, or any other definable input resource may be implemented to control the presentation and manipulation of features associated with embodiments of the invention.

The user may place a call to the selected contact by scrolling the highlighted focus element 44 to the desired number and pressing a confirmation key, such as a soft key labeled “call” 54. Upon selection of the “call” soft key 54 or other confirmation key, the mobile device initiates the call over the network and the user is presented with the exemplary call screen shown in FIG. 6. The call screen may include information relating to the call time and date 60, call duration 62, the name 56 and number 50 of the recipient of the call, as well as soft key labels for additional functionality, such as a mute button 64 or menu button 66.

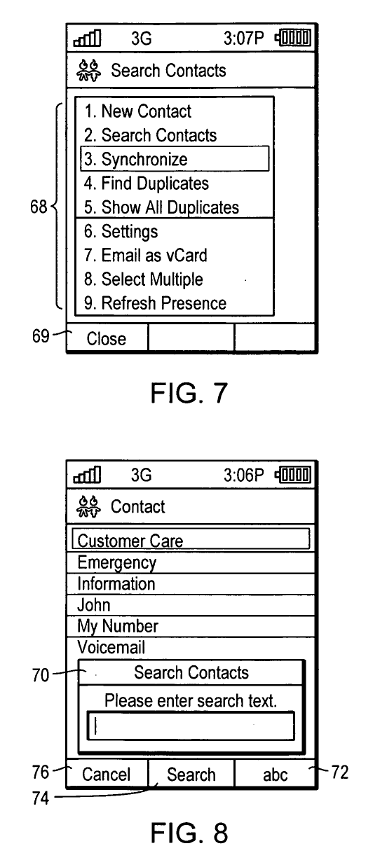

Embodiments of the present invention allow a user to access a variety of functionalities within the contact list of the mobile device as shown in FIG. 7. As shown in FIG. 7, the contacts icon may be used to initiate a search of a user's contacts. A list of menu options 68 is presented that may include, without limitation, access to submenus for creating new contacts, searching contacts, synchronizing contacts, finding or showing duplicate entries in the contact list, editing settings, emailing a contact as a file, or selecting multiple contacts.

As explained below, upon synchronizing the contact list, the various service providers, to which the user maintains and manages on the mobile device, are polled and relevant informational objects, such as contact data, are gathered for presentation on the device. The user may exit the menu by pressing the “close” soft key 69. Although the use of soft keys that map to portions of an input device are referenced herein, different aspects of the user interface can be configured to be directly accessible by any of the input devices associated with the mobile device.

Initiating a search for a contact will present the user with a display such as the display of FIG. 8. In one embodiment of the invention, the mobile device is configured such that typing alphanumeric characters on the keypad automatically initiates a search relative to the interface page that is active. However, in other embodiments, the search is initiated independent of the active interface in response to a user enter characters on an input device, such as a keypad.

An internal dialog box 70 is presented in which the user may type or enter a name, number, or other identifying characters to search. An input mode soft key 72 may be available to toggle between various input methods on the mobile device keyboard. These modes may include, without limitation, lower-case alphabet (as indicated by “abc”), uppercase alphabet (as indicated by “ABC”), Sentence case (as indicated by “Abc”), numeric only (as indicated by “123”), a predictive text input, such as T9 (as indicated by “T9Abc”), Korean character case (“Korean”), or any other suitable text input protocol. When the appropriate search characters have been entered in to the dialog box 70, the display allows the user to then initiate the search by pressing a confirmation key or “Search” soft key 74. The display also presents the user with the option to cancel the search by pressing a “Cancel” soft key 76.

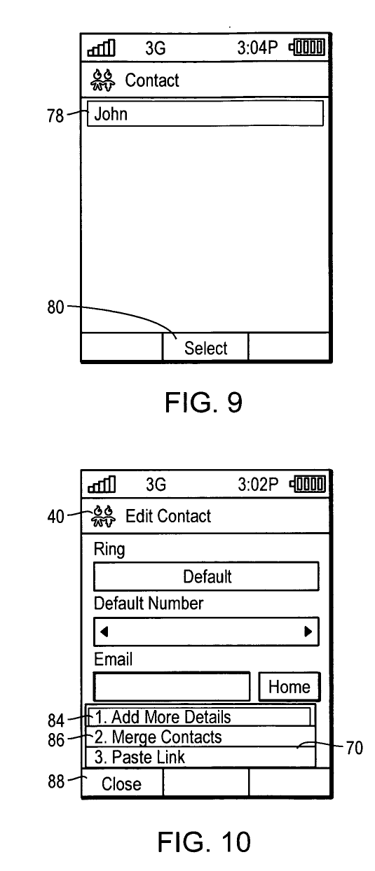

Upon retrieval, a hit-list of possible contacts is presented to the user. For example, if a user entered “JOHN” and executed a search, a display such as the display of FIG. 9 may be presented to the user listing the contact entry or entries 78 as results of the search. If multiple contacts exist with a reference to “JOHN” contained therein, each entry may be listed in the display. The display provides a “Select” soft key 80 allowing the user to enter the submenu of the selected contact, similar to that of FIG. 5. If multiple contact entries 78 are returned, the focus element may be scrolled to highlight the contact of interest for selection with the “Select” soft key 80.

In one embodiment, the system is implemented on a dual-direction, sliding mobile device such as the Ocean from Helio, Inc. Such a device provides a slideable QWERTY keyboard when in a landscape mode, while also providing a slideable traditional telephonic keypad when in a portrait mode. In one embodiment, a modeless dynamic contact search is employed, in which, as the user types the characters, the mobile device performs a real-time search after each character is entered. For example, after pressing the “J” key from the standard QWERTY keypad (“landscape mode”), all entries beginning with “J” will be presented. Upon pressing the “O”, all entries beginning with “JO” will be presented, further refining the results list as additional characters are entered. Embodiments are also utilized with the standard telephone keypad (“portrait mode”) which contains the capability of having all combinations of the three letter keys entered presented on the display. For example, upon entering “5”, any entries beginning with “J”, “K” and “L” will be presented.

Additional characters further refine the results list with the possible combinations of the three letter telephonic buttons. At any time during the refinement (or narrowing) of the results list, the user may navigate the focus element to a specific returned contact. Following this navigation to the intended contact the user may view with softkeys the entered address book information for that entry. Using the back navigational key will also subsequently eliminate an entered character in the search, thus dynamically (re)increasing the list of refined results possible.

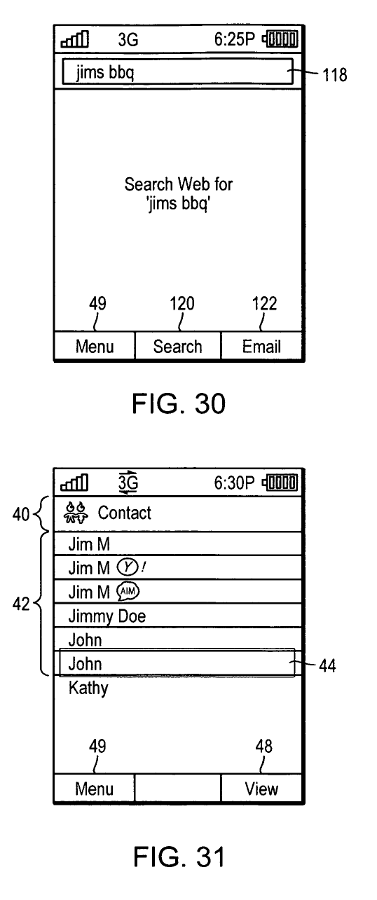

FIGS. 30 and 31 present the alternative displays of embodiments of the invention in which a “landscape mode” display is implemented on a mobile device. As shown in FIG. 31, entering a number, from a QWERTY keyboard device for example, lists the contact results 42 having the first character entered (“J”) followed by any contacts beginning with subsequent letters of the alphabet (“K”) given allowable display space. The search characters may be indicated in the results list 42 using techniques such as, but not limited to, underscores, distinct character colors or both.

In an embodiment, the modeless search functionality may also be expanded to execute a web search for entered text, from a QWERTY keyboard for example, as shown in the display of FIG. 30. Upon entering a character, a search banner 118 is shown containing the search characters entered by the user. A “Search” soft key 120 is also displayed allowing the user to initiate the web-based search. If the character entry still creates a refined list of address book entries (not shown in FIG. 30 but a primary user experience), the member may navigate to the character list in the search banner 118 and select the “Search” soft key 120 which will be displayed upon navigation. If the character count has exhausted any possible contact entries, the invention will move the focus to the search banner and dynamically show the “Search” soft key 120. Upon selecting “Search” 120, the invention will pass a parameter with a search string of the entered characters via the device to the browser and associated chosen search engines (i.e. one result from Yahoo, one result from Google, one result from Amazon, etc.).

While refining the list of address book entries, an “Email” soft key 122 is also presented allowing the user to initiate the composing of an email to an entered email address. The display also presents the user with a menu soft key 49. The display of FIG. 31 includes the informational banner 40 signifying the entry into the “Contact” menu and a listing of several informational objects or contacts 42. The user may select a particular informational object by scrolling a highlighted focus element 44 to the desired object. In the display of FIG. 31, the contact listed as “John” is the desired contact. The user may view the contents of the contact record by pressing a confirmation key or a “View” soft key 48 when the desired contact is highlighted by the focus element 44.

While the embodiments above are described as implemented on a dual-slider mobile device, one skilled in the are should recognize that embodiments of the invention may be implemented on any mobile device platform, including but not limited to, clam-shell or flip devices, slider devices, or any other mobile device footprint.

Again, once a contact has been found, or selected from a list, the user may enter a series of displays to edit the contact information associated with the particular contact or to create a new contact. FIGS. 10-15 depict various displays presented to the user during such an operation. The display will present the information already stored for the contact as well as blank dialog boxes for entries that have not been populated. The user may then, by selecting Edit Contact from a menu item, edit any of the information boxes and save the contacts. Upon initiation of the edit functionality for a particular contact, as shown in FIG. 10, the user may choose to add additional details 84 or to merge the contact 86 with another. The informational heading 40 indicates the “Edit Contact” submenu. A “Close” soft key 88 is also displayed allowing the user to exit out of the menu.

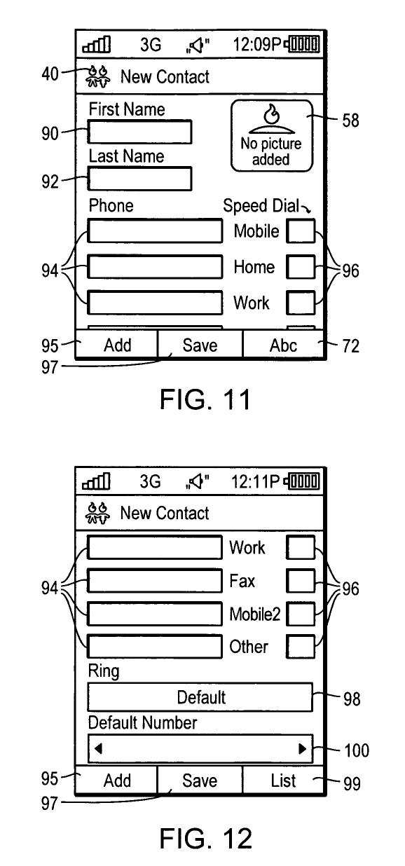

Upon initiating the creation of a new contact via this manner or simply selecting function from Contacts menu, the user is presented with a blank template, as shown in FIGS. 11 and 12, indicated by the informational heading 40 and having open dialog boxes for various fields, including without limitation, first name 90, last name 92, various phone numbers 94 for different locations (i.e. cell phone, home, business, etc.) and speed dial assignments 96. In one embodiment, an identifier 58, such as a logo, picture or avatar, may be included in to the contact record. A specific ring-tone 98 may also be chosen for the particular contact. A “Default Number” field 100 is also displayed to indicate which of the contact's numbers, if more than one is included, the mobile device may default to when placing a call. A “List” soft key 99 is displayed when the focus element 44 highlights the Default Number field 100. Pressing the List soft key will allow the user to select the default number from a list having all the contact's stored numbers. Additional informational fields may also be included in the contact's record such fields to contain email addresses 102, instant messaging aliases or usernames 104 and hyperlinks 106 to personal web pages or web logs.

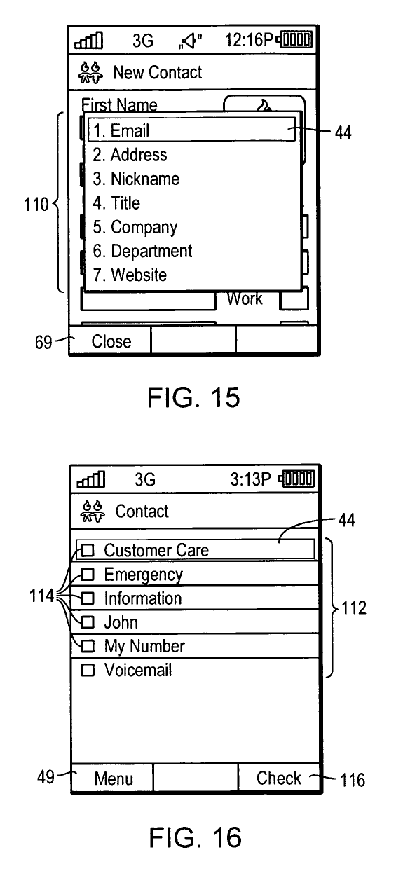

A “Notes” field 108 may also be included to contain any comments the user may wish to store for a particular contact. Additionally, a “Group” field 52 may be used to segment or categorize the contact into pre-defined collections. Examples of possible groups include, but are not limited to, friends, family, work, co-workers, school, other, none, or other user-defined groups. When entering contact data a user may jump to certain fields upon selecting a certain key or button, or scrolling the focus element 44 to the desired option, as shown in the display of FIG. 15 selecting one of the field options 110 presented to the user will move the text input focus to the selected field.

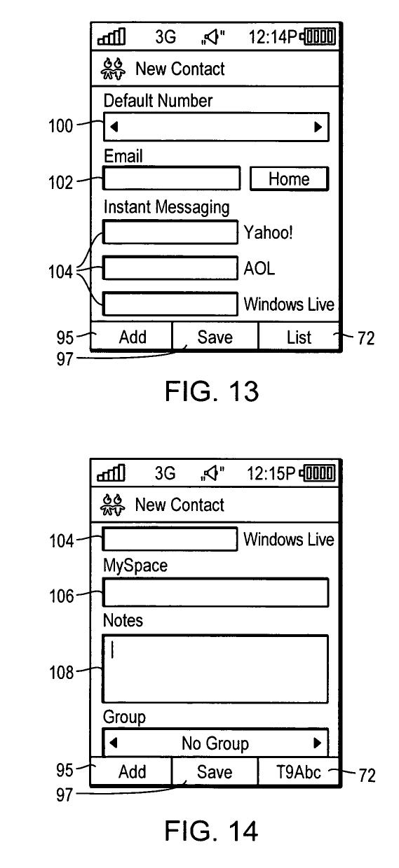

Embodiments of the IMS present the user many of the informational fields in the initial display of the screen in FIG. 13. An “Add” soft key 95 is displayed while accessing the screen and can be pressed to present additional informational fields, as shown in FIG. 15. The user can select from the additional information fields 110 by navigating the focus element to the field and selecting it with the center select key. After selecting the field, it will be displayed in the list of informational fields available for entry in the Contact. Following the selection, an IMS embodiment can then remove the information field from the list of additional information fields 110 which are available for the ‘Add’ function. This is with two exceptions with Email and Addresses which one IMS embodiment allows multiple entries. These are removed from the list of fields after the maximum setting of available entries is reached (eg, five (5) email addresses). The user, when done editing the contact record may select the “Save” soft key 97 to save all the newly entered data into the memory of the mobile device.

Embodiments of the IMS also allow for editing, copying or deleting of existing contact information. By navigating the focus element 44 to an appropriate Contact, a user may press the Menu key 49 and select any of these options. Copying functionality allows the user to create a copy of an existing contact to another instance of an address book (eg. AOL, Yahoo!) besides the initial source.

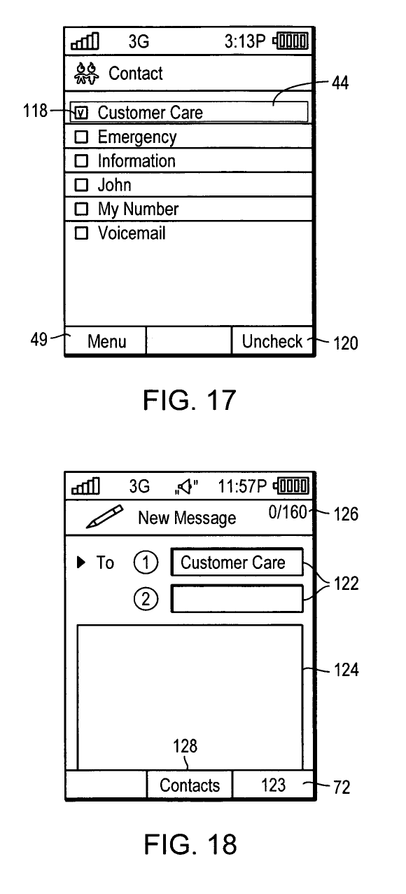

In an embodiment of the invention, a user may select a contact or multiple contacts for the deletion of contacts. Pressing the Menu key 49 will also present an option to select multiple contacts. The resulting screen, as shown in FIG. 17, will present a check box by each contact. By using the soft key Check, the user may select multiple contacts. In this embodiment, the selected contacts have a checkmark 118 filling the boxes next to the contact name. A soft key labeled “Uncheck” 120 may also be presented when an already-checked contact is highlighted by the focus element 44. When all desired contacts are selected, the user, via the menu soft key 49, is presented with the message template display as shown in FIG. 18 in which the user may then delete multiple contacts at one time.

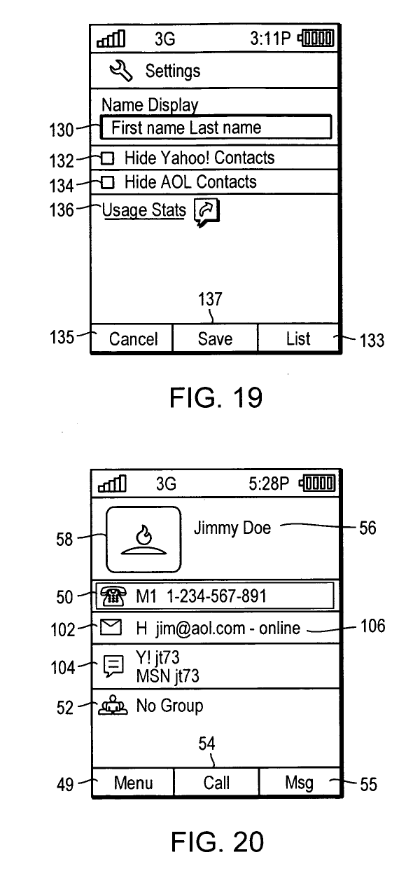

Embodiments of the invention also allow a user to customize the manner in which the contact names are displayed. FIG. 19 depicts an illustrative display in which the user may select how the contact's name is displayed 130 (i.e. last name first, first name first, etc) as well as the option to hide certain contacts. By selecting the List soft key 133 when the Name Display field is highlighted, a list of possible display options may be presented to the user. In the display of FIG. 19, the user is presented with checkboxes 132, 134 indicating the options of hiding Yahoo! or AOL Contacts. The user may then save the settings by selecting the save soft key 137 or may select the cancel soft key 135 to return to the previous display. The user is also presented with a link 136 to a display showing usage statistics highlighting the current number of contacts on the device and synchronized from the various sources.

Embodiments of the IMS include modular storage, presentation, and synchronization protocols for contacts synchronized from sources such as, but not limited to Helio, AOL, and Yahoo!. According to one embodiment, the IMS stores appropriate contacts in a modular manner for various content sources, yet creates a common integrated presentation of all device contacts 112. An embodiment of the invention is then the ability to synchronize between 3^{rd} party providers.

Turning now to FIGS. 20-22, illustrative displays of the contact records are shown. The display may include an indicator icon 58 such as a photo or other image to be associated with the contact. The contact record display includes all entered contact information including, but not limited to; the listing of phone numbers 50, email addresses 102, chat or instant message aliases 104 as well an provider indicator 106 signifying the service provider to which the alias is associated (e.g.Yahoo! or MSN). In certain embodiments, the indicator 106 may signify whether a contact is signed-in to the service, or online, allowing the user to send a instant message or chat request. A source indicator 108 is also included to indicate from which portal or service provider the contact record data was taken. Membership to any user-assigned groups 52 (e.g. family, business, friends, etc.) may also be presented in the contact record display. The user is also presented with a menu soft key 49 to display certain operational options, a call soft key 54 to directly initiate a call to the contact, and a “Msg” soft key 55 to initiate the send message template (FIG. 18).

As mentioned above, synchronizing the user's contacts via the menu soft key 49 (FIG. 7) in the contacts list allows for an aggregated contact display in which contact information from multiple service providers may be presented. When a synchronization operation is initiated, the mobile device transmits a request across the network and through the Internet to the various service providers to which the user has configured the device. The service providers are then polled for the contact information stored in the user's account and transmitted back to the mobile device via the WCDS and populated into the contact records. Service provider indicators, in some embodiments allow the user to know which alias or email belongs to which account as well as if certain contact are online and signed in to the service.

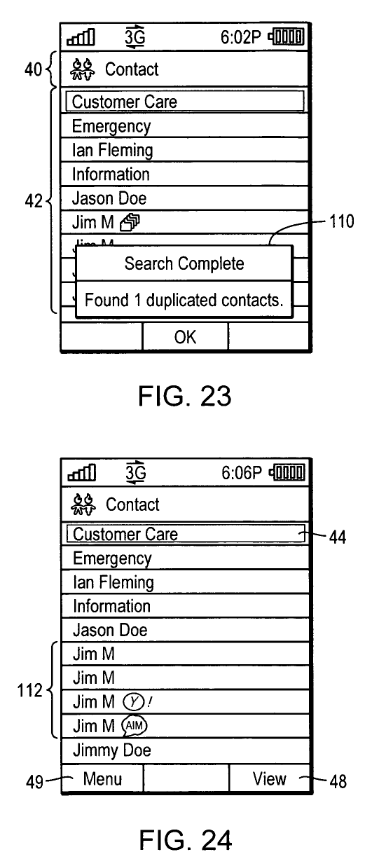

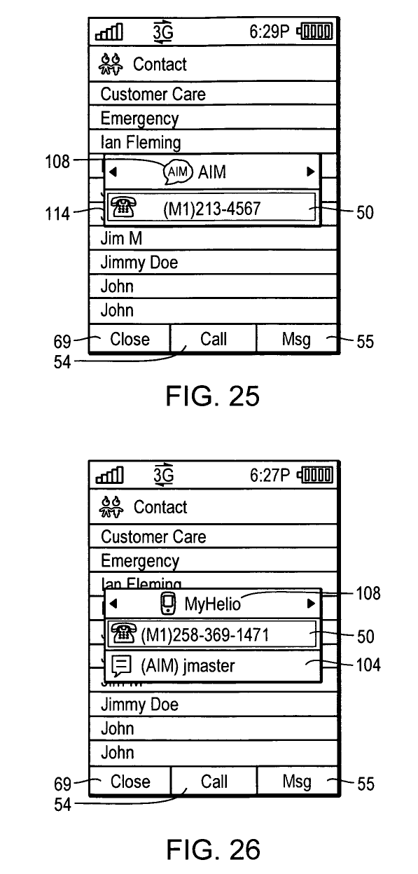

The user may also manage the data contacts retrieved from the service providers by grouping duplicate contact entries from the menu screen (FIG. 7). FIG. 23 depicts a display headed by the informational banner 40 with contacts 42 in which the results of a duplicate search are presented to the user via an overlaying dialog box 110. In one embodiment, as shown in the display of FIG. 24, all duplicate records or names 112 are listed. The records contain a service provider indicator 108 which signifies to the user from which service provider account the contact was received. In the illustrative embodiment a contact, “Jim M” is listed repeatedly across multiple accounts (i.e. one entry from Helio, one entry from Yahoo!, one entry from AIM, etc.) Scrolling the focus element 44 and highlighting the duplicate entries, as shown in the displays of FIGS. 25-27, present live floating dialog boxes 114 that allow the user to see the details contained within each record, such as the phone number 50, or chat alias 104. The call soft key 54 and Msg soft key 55 are presented allowing the user to directly initiate a call or message to the highlighted user.

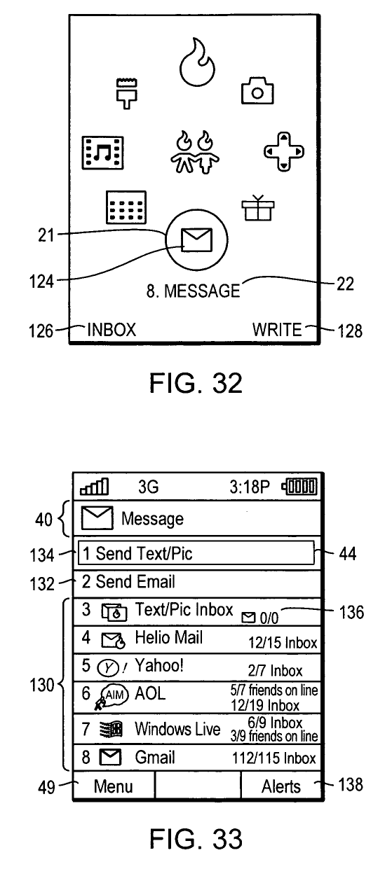

In another aspect of the invention, an integrated messaging system is implemented that integrates and aggregates a user's electronic messages and non-verbal communications (e.g. e-mail, text messages, online chat, instant messaging, etc.) into a single collection of menus and submenus. FIGS. 32-47 depict various displays as presented to the user according to embodiments of the invention.

The user may be presented with a display of the mobile device, as in FIG. 32 (and FIG. 3), with a variety of native functionalities resident on the device. Examples of such functionalities include, without limitation, a camera, Internet browser, games, music, calendar, or address book. The user highlights or scrolls the focus circle 21 to the “Message” list, here the envelope icon 124, and confirms the selection by pressing a confirmation key. A descriptor field 22 describes the menu function highlighted by the focus circle 21. With the “Message” icon 124 highlighted, the user may enter the Inbox of the messaging system by selecting a confirmation key or the “Inbox” soft key 126. The user may also enter into a message writing template (FIG. 18) by selecting the “Write” soft key.

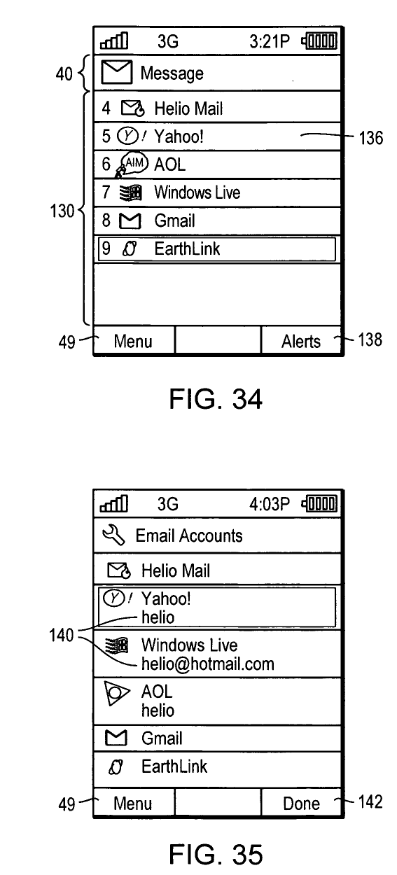

Upon selecting the Inbox, the user is then presented with an aggregated message page, interface, or portal as shown in the displays of FIGS. 33 and 34. The display may contain, under the informational banner 40, a listing of multiple email or service provider accounts 130 in addition to links to any native messaging or other functionalities, such as text message or native email provided by the mobile device service provider. In the embodiment depicted in FIG. 33, the user is presented with a shortcut to a “Send Email” 132 or “Send Text” 134 menu in addition to the listing of service provider accounts. For certain providers, status indicators 136 may be presented proximately to the account provider name. The indicators 136 may specify a number of unread messages or a ratio of unread to read messages. A user may access the content to each account by scrolling the highlighted focus element 44 to the desired account and pressing a confirmation key or button. An “Alerts” soft key 138 is displayed to allow the user to access notification and alert settings for sending and receiving events, as described in further detail below.

One embodiment of the IMS also allows members to customize their viewing of the various messaging services shown in FIG. 33. As shown, multiple third party providers and messaging services are aggregated and integrated in a common pane on the mobile device. The invention allows user to select a “Move” feature from the menu 49 and resort the order to focus on those elements which they use most frequently. One skilled in the art should recognize that this functional design provides the user freedom in enhancing the mobile experience to mirror their online priorities.

In certain embodiments, upon scrolling the focus element 44 to the desired account, the user may be presented with live window displaying a number of informational objects. These informational objects may include, without limitation, status info, such as a scrolling list of the newest unread messages, photographs of the contacts who have emails waiting for the user in the inbox, etc. One skilled in the art should recognize that any informational object relating to the underlying account may be displayed in such a manner without deviating from the scope of the invention.

A user may access an aggregated accounts display via the menu soft key 49, as shown in the display of FIG. 35, in which the user may edit, add, delete, or modify settings to each account. Such settings may involve custom integration with various email and instant messaging solution providers (i.e. Yahoo! service, AOL services, MSN services, etc.) as well as the ability to access user defined email providers via industry protocols (i.e. IMAP or POP3). In one embodiment, the user's specific username or email address 140 may be presented below the name of the service provider.

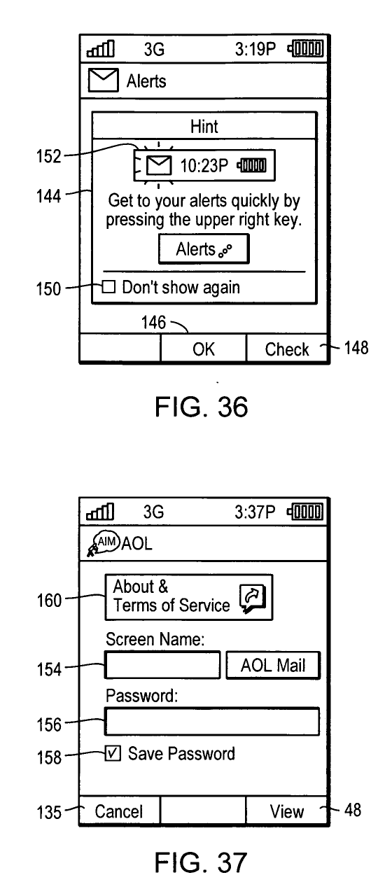

In an embodiment of the invention, the user is notified upon receipt of an informational object, such as an email, text message, chat request, etc., by an alert as shown in FIG. 36. In this illustrative example, the user may be notified of an incoming informational object with a “Hint” 144 instructing the user how to more quickly access the alerted content. The user is presented with the option of removing the “Hint” 144 from future presentation by selecting a checkbox 150 via the check soft key 148. A confirmation soft key 146 will take the user to the newly delivered informational object. Additionally, when an informational object is received, an indicator 152 may be displayed in a prominent location on the display, such as at the top of the screen near a time, date or battery-life indicator.

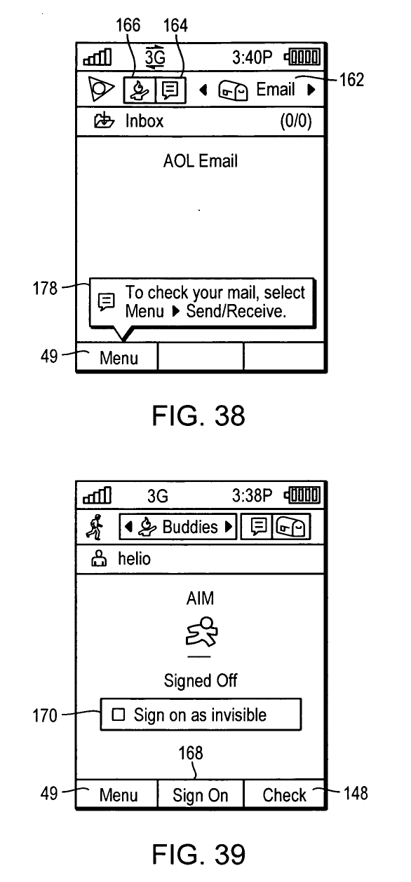

Upon selection of a particular service provider account from the aggregated message interface, the user, in one embodiment, is presented with a log-in screen such as the display depicted in FIG. 37. The user can authenticate an account by entering information into a username or screen name field 154 and a password field 156. The user types in the appropriate username and password which is transmitted to the service provider over the network. If the log-in credentials are correct, the user is authenticated and the user is presented with a portal submenu such as shown in the display of FIG. 38. In some embodiments the user is presented with the option of saving the log-in credentials by selecting a checkbox 158 to expedite the process in accessing the content in the future. In one embodiment the user is presented with a link 160 to the Terms & Conditions of Service provided by the 3^{rd} party service provider. Selecting the link 160 may display a web page or text file detailing the Terms & Conditions of the use of the portal's services.

The portal submenu, in certain embodiments, contains a series of tabbed interfaces representing the functionalities of the service provider. In the illustrative example shown in FIG. 38, an email tab 162, a chat tab 164 and a contact list tab 166 are presented to the user. The user may easily navigate back and forth through the tabbed interfaces by highlighting the extended portion of the currently viewed tab and pressing a left or right directional key, or pressing a key assigned to toggle between the tabbed interfaces. The user is presented with a menu soft key 49 which is adjusted depending upon the tabbed interface to which the user has currently navigated. It is also adapted as necessary for a given email and instant messaging provider.

For the email tab the menu key 49 may be used to execute certain functional commands, such as signing off, send/receive email, search, compose, etc. Certain embodiments of the invention provide pop-up informational bubbles 178 to offer suggestions on how to utilize or maximize the efficiency of the mobile device. Information included in the bubbles 178 may include, but are not limited to, shortcuts, instructions for sending/receiving messages, underlying functionalities of a particular menu of soft key label, and other helpful hints. The tabbed interfaces within the submenu of the service provider account replicate the functionalities of the service provider on the mobile device. In the example shown in FIG. 38, the user has signed into an AOL™ account. The user may send and receive AOL™ email, chat via an instant messenger, or examine the contents of the “Buddy List.”

If the user wishes, upon completion of any operations within the portal submenu of the service provider account, the user may sign off via the menu soft key 49. Upon signing off of the AOL™ account, the user may be presented with the display shown in FIG. 39. The user may be given the option of signing back in via a “Sign-In” soft key 168. A checkbox 170 is provided that allows the user to sign in as invisible, i.e., other online-users are not notified of the user's online status. The user may highlight the checkbox 170 and press a confirmation key of check soft key 148 when the checkbox is highlighted.

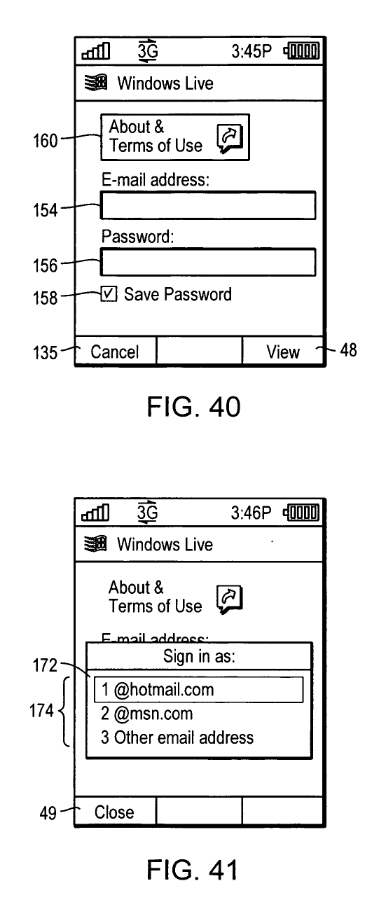

FIGS. 40-43 depict the submenu and tabbed functionality interfaces of an account through Microsoft's Window's Live™ service. Similarly to those of FIGS. 37-39, the user logs in to the account by entering information into an email address field 154 and a password field 156. The user is also presented with the option of saving the log-in credentials by selecting a checkbox 158 to expedite the process in accessing the content in the future. In one embodiment the user is presented with a link 160 to the Terms & Conditions of Service provided by the 3^{rd} party service provider. Selecting the link 160 may display a web page or text file detailing the Terms & Conditions of the use of the portal's services.

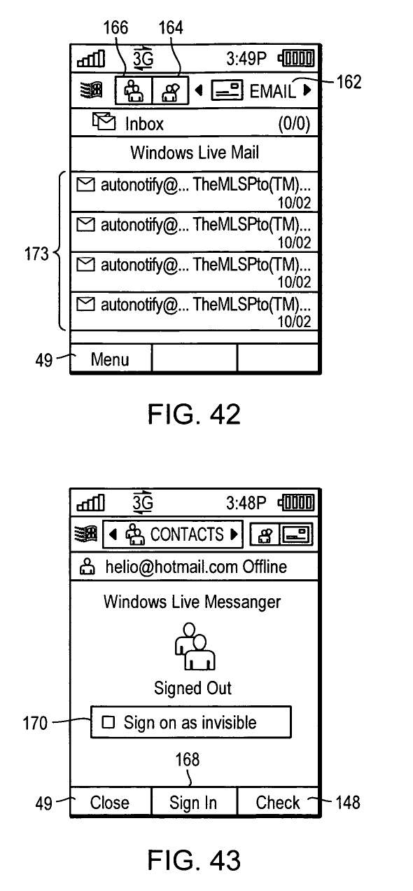

In an embodiment, as shown in FIG. 41 the user may be presented with a dialog box 172 providing a list of optional sign-ins 174 such as through a Hotmail™ account, an MSN™ account or another email address. These options are replicated as if the user was signing into the service from a desktop or laptop computer. The display of FIG. 42 depicts the tabbed functionality interfaces for email 162, chat 164 and a contacts list 166, as described above. Upon signing off of the account, the user may be presented with the display shown in FIG. 43. The user may be given the option of signing back in via a sign-in soft key 168. A checkbox 170 is provided that allows the user to sign in as invisible. The user may highlight the checkbox 170 and press a confirmation key of check soft key 148 when the checkbox is highlighted.

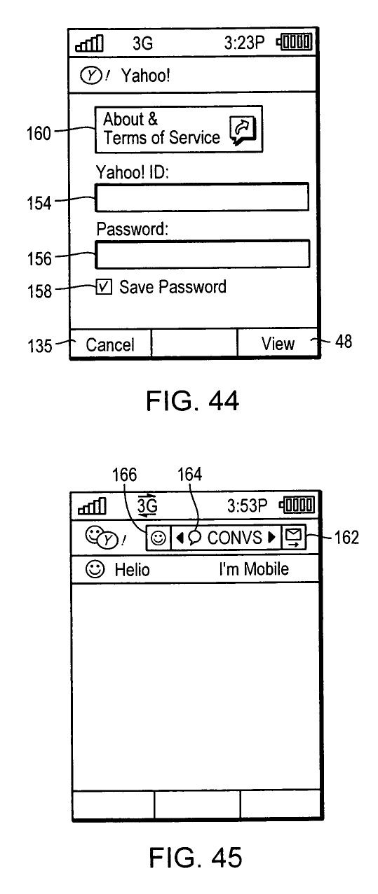

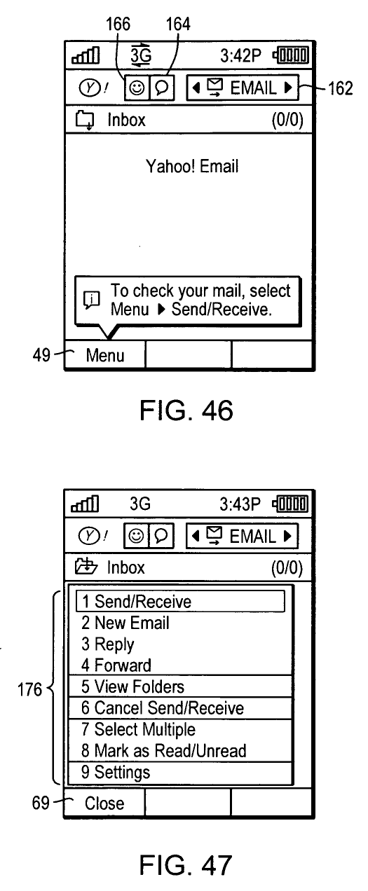

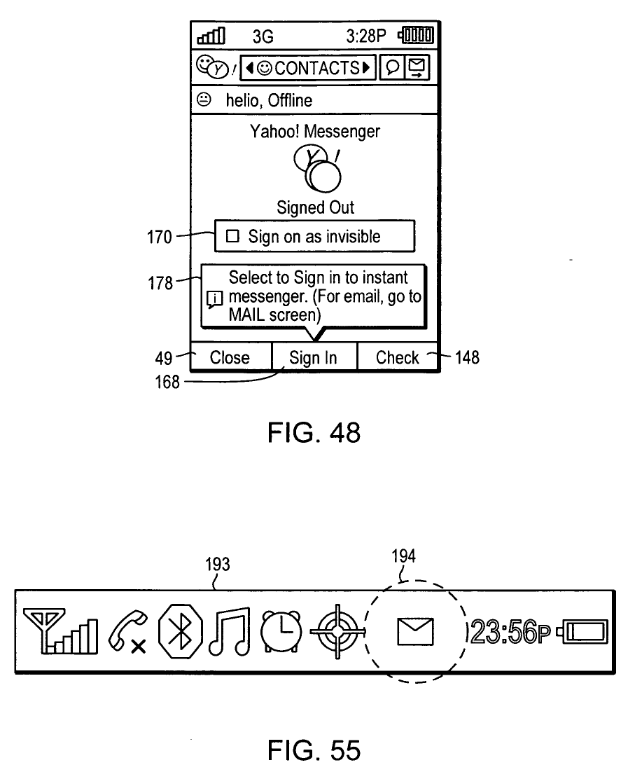

FIGS. 44-48 depict the submenu and tabbed functionality interfaces of an account through Yahoo!™ service. Similarly to those of FIGS. 37-43, the user logs in account by entering information into an email address field 154 and a password field 156. The display of FIGS. 45 and 46 depict the tabbed functionality interfaces for email 162, chat 164 and a contacts list 166, as described above, presenting the chat functionality interface 164 in FIG. 45 and the email functionality interface 162 in FIG. 46. FIG. 47 depicts the display of the menu options 176 available within the email tabbed interface 162 including options to send/receive, create new email, reply, forward, view folders, cancel send/receive, select multiple messages, mark as read/unread and access to account settings. Upon signing off of the account, the user may be presented with the display shown in FIG. 48. The user may be given the option of signing back in via a sign-in soft key 168. An informational bubble 178 is shown in the illustrative example. Additionally, a checkbox 170 is provided that allows the user to sign in as invisible. The user may highlight the checkbox 170 and press a confirmation key of “Check” soft key 148 when the checkbox is highlighted.

Embodiments of the invention include an intuitively navigable user interface through which a user may access and utilize the functionalities of 3^{rd} party service providers. Portals are provided replicating the functionalities of each of the service providers. These functionalities include, but are not limited to, email accounts (POP3, IMAP, etc.) Chat, IM or other instant messaging services and address books, contacts or Buddy lists. The embodiments described herein provide similar capabilities within each of the functionalities, such as setting a status broadcast in a chat environment, providing a chat or SMS thread or stream of messages, etc.

Such embodiments also include presenting the ability to send, receive, read, and managing email communication. As shown in FIG. 42, the email tab 162, when navigated to and following a log-in and synchronization of messages with the online service provider, shows as a default the received email messages 173 in a user's inbox. This is sorted by date by default. The invention also features the ability for the user to sort a message folder by sender or subject. Such features provide consistentency in these controls while adjusting them as necessary based upon various online service provider requirements, both those adjusted by embodiments of the IMS as well as those the user is allowed to customize.

The menu key 49 allows for the selection of items (not shown) for the various email management embodiments of the invention. These embodiments include the familiar online email elements of being able to send/receive to synchronize the visible folder with its online version provided by the online service provider. Additionally, IMS embodiments include the ability to compose a new email message, as well as to reply or forward the currently navigated to message. Another embodiment is the ability to navigate from the same menu structure to additional system (eg, Sent, Drafts, Deleted) as well as user generated folders. From the menu, users may also toggle various message as “read/unread” as necessary to support the email management.

While composing a new email message, one IMS embodiment also provides features to add various attachments, as shown in FIG. 56. The IMS embodiments are integrated with various elements of device storage areas and functionality within the mobile device. Attachments can thus be selected from several options 189, including Photo Album, Video Album, customized Email Storage folder areas, or external memory sources. Additionally, custom integration with the camera is enabled to take a picture or video. In one embodiment, the IMS automatically transfers the user-generated image or video and adds it to the open email.

Another embodiment of the invention includes a module with the ability for users to customize the scope, size and performance impact of their email instances on the mobile device from a folder options setting. The settings 190, as shown in FIG. 57, allow for the selection of “Folder Options”. As shown in FIG. 58, various user settings 191 within the Folder Options allow the user to modify the number of messages, the size of the initial preview email, and the maximum size of the message. The user therefore has the ability to find the optimal balance of download speed versus the amount of content shown on a per mailbox and per message instance.

Further, from email settings 190, as shown in FIG. 57, a user can select “General” settings for a particular email instance. From these settings users may add and customize an email signature to be attached to an outgoing message. Additionally, they may select if they wish to receive email alerts for the customized email experiences.

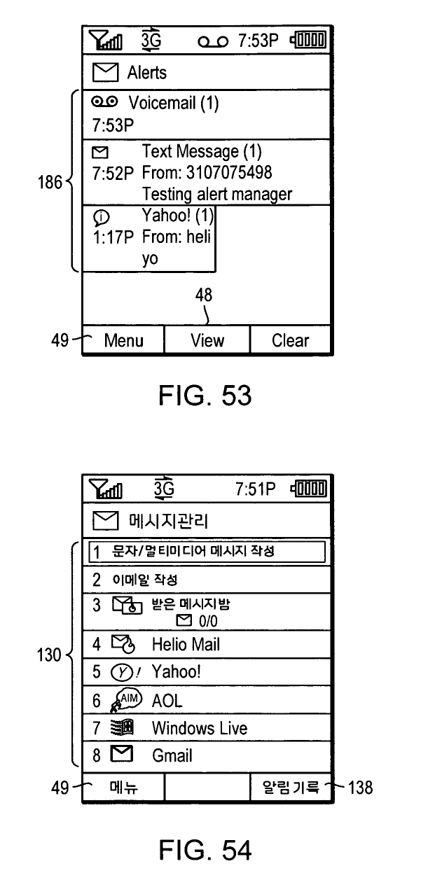

Such alerts for email, instant messaging, voicemail and other events along with the coordinated viewing of various alerts 186 are displayed in an Alert Manager in one embodiment of the invention as shown in FIG. 53. Integration with the online service providers allows one embodiment of the invention to be notified of various incoming emails and requests for instant messaging chat sessions. From the Alert Manager, a user may press a View key 48 in order to display additional details of the alert. The user may also opt to clear the alert by pressing a Clear key 187. Through a device alerting mechanism, these alerts from the service providers are silently communicated to the device. Upon such a notice, one embodiment of the IMS moves from an idle state to a background state, though this action is invisible to the user. While in such a background state, the one embodiment of the integrated messaging systems works with the device to create a data connection to retrieve the specific email message or instant message chat information to which it has been alerted.

Upon successful completion of this retrieval of information while in a background state, the IMS embodiment will provide a pop-up alert to the user, as shown in FIG. 59 item 192. This alert may then acted upon by the user. Options may include ignoring the alert by pressing an Ignore key 188 (returning the device back to idle mode), viewing the entire Alert Manager, or “View” 48 which will take the user to the specific alerted email or instant message chat information retrieved. Incoming alert pop-ups 192 will remain on the user's screen until acted upon or if another alert is received by the device. The most recent alert received will remain in the idle screen until a specific user action is taken. The Alert Manager has also been adapted for IMS alerts (eg, various provider emails, or instant messaging chats) to be bundled within the IMS along with other device alerts, including but not limited to; Voicemail, Text Messages, Picture/Video Messages, and additional customized messages from other device applications (eg; community applications, photo/video storage applications, location-based friend finder applications, games, etc. . . . ).

Another embodiment of the invention related to the alerting mechanisms is the rotation mechanism in the device's annunciator bar 193, as shown in FIG. 59 and more closely in FIG. 55. As alerts are recognized by the device they will not only create a pop-up, but will also create an annunciator notification 194. These notifications 194 may be shown by the device in a systematic, time-based, rotating manner highlighting sequentially all various alert types received. Such alerts rotate until such time that the content creating the alert is acted upon by the user or specifically cleared.

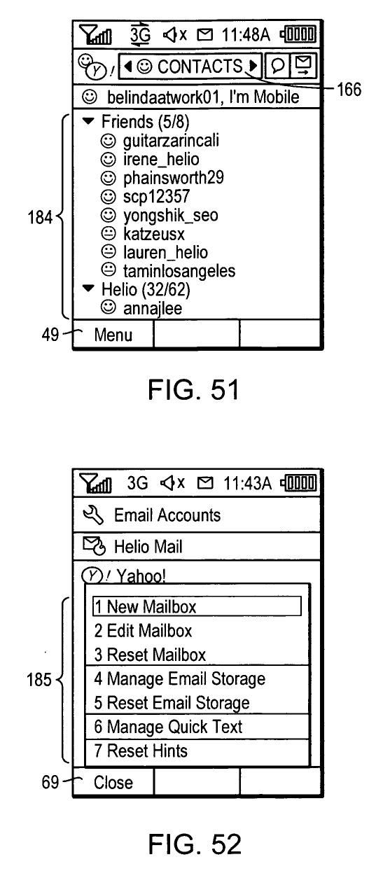

The ability to manage various online service provider's instant messaging services all within the same solution is another embodiment of the application. When logged into any specific service, as shown in FIG. 51, the list of associated instant messaging friends 184 is shown in the first tab 166 of each customized online service provider. Each may then be adapted in accordance with the online provider's instant messaging requirements, generally showing group headings and associated Friends belonging to each group. Instant messaging friend's visibility settings and presence is tailored in accordance with online service provider parameters, but generally user may select to show all friends or only those currently online and showing a logged-in status. Users may navigate the focus element to any friend and use a softkey to initiate an instant messaging chat (“Send IM”).

Additionally, softkey functionality lets the user “View” a members address book information if saved, if contact information has not been saved a user prompt will be initiated asking the member if they would like to save the contact to the invention's address book. The management of the friend list within an instant messaging instance also may allow the user to add or block various invitation requests to add other users as friends from the invention. Additionally, another feature here is the ability to change, or customize your status as other friends of the online service provider's instant messaging service will view it from the device.

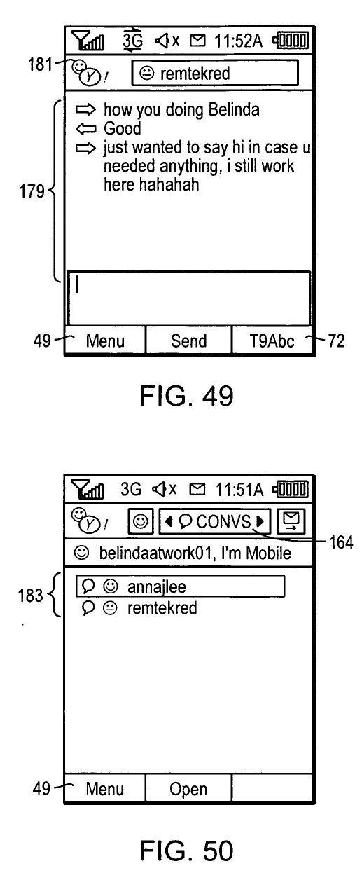

Following the selection of a specific friend to begin an instant messaging chat with, a screen allowing for the entry of instant messaging chat text and the viewing of the various messages associated with a specific chat will appear, as shown in FIG. 49. The text entry box 180 will be the initial prompt for the user, and the user can begin entering text as appropriate from either landscape mode or portrait mode. (Text entry mode is managed via the softkey as necessary as described previously) Upon completing appropriate text entry, user may press softkey to send to the selected friend. The entered text will be migrated from the text entry box 180 to the message history area of the screen 179. Received text from a friend will also be placed into the message history area of the screen 179. Entered and received text will be shown sequentially, and will have visual indicators to differentiate either. Various text and message content tools are provided allowing the user to quickly insert traditional text messaging symbols, emoticon, quick text (saved phrases designed to accelerate commonly used text), and copied URLs or Phone Numbers. Another embodiment includes a visual representation 181 of the friend's presence status (or online-status indicator) in the open instant messaging chat window.

Another embodiment of the invention is the incorporation of file transfer over IM via the mobile device. Embodiments of the invention allow for the selection of attachments from the various device storage areas including Photo Album, Video Album, customized Email Storage folder areas, or external memory sources. Additionally, custom integration with the camera is able to take a picture or video and automatically transfer the user-generated image or video and add it to the open instant messaging text window.

In one embodiment, upon exiting a specific instant messaging chat, the user will be prompted to the open conversation tab 164. As shown in FIG. 50, all open chats 183 will be shown. Ordering of the chats may be in various preferences, but initially being shown in order of most recent on top. The various online presence statuses of the friends listed for open conversation chats will also be shown with various visual indicators to show those online and those offline. Navigation of the focus element to various chats allows the user to (re)open any of the open chats shown in the screen. All chat message history will remain available as long as conversation has not been ended. A user may end a specific conversation or all conversations from various menu options within the Screen.

To access any of these functionalities on the user's mobile device, an idle screen or home screen may be activated to present the display showing the native applications or functionalities resident on the mobile device, as shown in more detail in FIGS. 3 and 32. A highlight circle or ring can be moved around to the various options and selected upon arriving at the desired feature. If there are multiple services configured or otherwise available on the device for a particular functionality, a list of choices is presented to the user. For example, upon selection of Messages from the home screen, a messages menu is displayed with a variety of options including a list of the various email accounts set up by the user is displayed in addition to shortcuts to compose an email or SMS message, or begin a chat. Upon selection of the “send email” option, a submenu is displayed listing all email accounts configured on the mobile device. The user may then select the account in which he or she would like to compose the email. A similar hierarchy may exist for chat clients or contact lists.

Similarly, upon selection of the contacts icon from the home screen, a Contacts menu view is displayed that may include an intermediary menu with options to continue to the listing of contacts stored on the device, or may display a number contacts logged-in to various chat services. The user may also chose to view groups of contacts based upon the stored Groups field in each contact's record. Proceeding to the contacts list provides an aggregated contact list as described in greater detail above. The user may then search by name or number to find a desired contact. Once the contact is located the user may initiate any number of functions including, but not limited to, emailing, sending an SMS message, placing a telephone call, initiating a chat, etc.

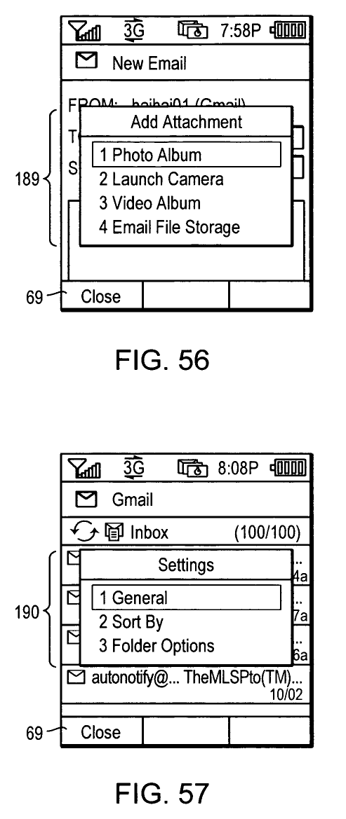

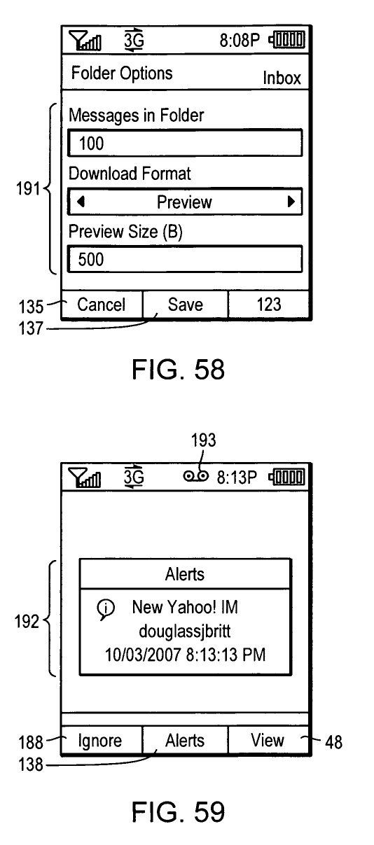

Another embodiment of the invention is the interaction between the solution and device language capabilities. A feature is the extensible architecture allowing different language character sets to be inserted throughout the user graphical presentation areas including the menuing options. This is shown in FIG. 54, with the feature being demonstrated with Korean language settings altering the menuing and service descriptions 130.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A system for organizing information for registered accounts on a mobile device comprising:
an aggregated content interface presenting a plurality of service provider indicators; and
a plurality of submenus corresponding to each of the plurality of service provider indicators of the aggregated content interface, each of the plurality of submenus including a plurality of tabbed interfaces, each of the tabbed interfaces replicating a functionality of the service provider.

2. The system of claim 1 wherein the aggregated content interface further comprises a contact indicator, the contact indicator providing a link to a contact submenu, the contact submenu comprising an aggregated contact list including contact data from the plurality of service providers.

3. The system of claim 2 wherein the contact data comprises a source indicator, the source indicator indicating the service provider from which the contact data is presented.

4. The system of claim 2 wherein the contact data further comprises an online indicator, the online indicator signifying a contact is online.

5. The system of claim 1 wherein the functionality of the service providers is selected from the group consisting of e-mail, instant messaging, chat, contacts, address book, logs, and archives.

6. The system of claim 1 wherein each of the service provider indicators further comprises a status indicia of the registered account.

7. The system of claim 6 wherein the status indicia indicates a number of unread messages out of a number of total messages.

8. A method of aggregating content from a plurality of service providers on a mobile device comprising:
presenting a plurality of service provider indicators in an aggregated content display pane, each of the indicators providing a link to a submenu;
presenting a plurality of messaging solutions for a service provider in a common display pane, at least one of the messaging solutions having a tabbed arrangement for instant messaging and email functions;
retrieving content over a network from each of the plurality of service providers; and
populating the submenu with the content, the submenu including a plurality of tabbed interfaces, each of the plurality of tabbed interfaces replicating a functionality of the service provider and displaying the content retrieved from the service provider.

9. The method of claim 8 further comprising presenting an aggregated contact list, the aggregated contact list including a portion of the content received from each of the plurality of service providers.

10. The method of claim 9 further comprising indicating an online status of a contact from the contact list.

11. The method of claim 9 further comprising indicating the source of the contact data, the source including at least one of the service providers.

12. The method of claim 8 wherein the functionality of the service providers is selected from the group consisting of e-mail, instant messaging, chat, contacts, address book, logs, and archives.

13. A mobile device, the mobile device comprising
an input device, the input device adapted to send a signal;
a processor, the processor adapted to receive the signal; and
a display, the display adapted to display a plurality of informational objects and a plurality of graphic user interface screens to a user in response to actuation of the input device, wherein at least one of the graphic user interface screens is a message aggregating portal that displays a plurality of third party messaging services and messaging service functions, wherein the messaging service functions associated with third party service providers are accessible via the aggregating portal.

14. The mobile device of claim 13 wherein all of the messaging services associated with the device are accessible via the messaging aggregating portal.

15. The mobile device of claim 13 further comprising a contact aggregation module, the module adapted to display address and contact information for all of the third party messaging services in the messaging aggregating portal.

16. The mobile device of claim 13 wherein inbox mail counts for each of the plurality of third party messaging services are displayed on the messaging aggregating portal.

17. A method of organizing messaging services on a mobile device, the method comprising the steps of:
aggregating a plurality of messaging services on a mobile device according to a hierarchical scheme; and
displaying a messaging graphic user interface in response to actuation of an input device, the messaging graphic user interface comprising a plurality of identifiers; each of the plurality of identifiers associated with at least one messaging service.

18. The method of claim 17 further comprising the step of polling a portion of the plurality of service providers to update inbox mail counts when the messaging graphic user interface is accessed.

19. The method of claim 17 further comprising the step of polling a portion of the plurality of service providers to update friend on line status indicators when the messaging graphic user interface is accessed.

20. The method of claim 17 further comprising the step of polling a portion of the plurality of service providers to update inbox mail counts when the messaging graphic user interface is accessed.

21. A personal information manager subsystem adapted for use on a mobile device, the subsystem comprising:
a network interface, wherein the network interface accesses third party messaging service providers;
a processor disposed within the mobile device, the processor programmed to instruct the network interface to retrieve personal contact information from a plurality of third party messaging services;
a display, the display in electrical communication with the processor; and
a graphical user interface, the graphical user interface presented to a user via the display; wherein the graphical user interface displays a master contact list that aggregates all of the retrieved personal contact information from the plurality of third party messaging services.

22. The subsystem of claim 21 wherein the third party messaging services are selected from the group consisting of Yahoo! mail, AOL mail, AIM mail, Microsoft's Hotmail, WindowsLive, Google's gMail, Earthlink's email, an IMAP solution, and a POP3 solution.

23. The subsystem of claim 21 wherein the third party messaging services are selected from the group consisting of Yahoo! IM, AOL's AIM, Microsoft's MSN, and WindowsLive.
